(19) United States
(12) Patent Application Publication
(10) Pub. No.: US 2009/0231614 A1
(43) Pub. Date: Sep. 17, 2009

(54) Image processing apparatus, image forming apparatus, and image processing method

(75) Inventor: Seiichiro Oku, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/382,197

(22) Filed: Mar. 11, 2009

(30) Foreign Application Priority Data
Mar. 13, 2008 (JP) 2008-064160

(51) Int. Cl. G06F 15/00

(52) U.S. Cl. 358/1.15

(57) ABSTRACT

An image processing apparatus includes a timing signal generation unit, a delay time information output unit, and a drive unit. The timing signal generation unit generates a timing signal showing timing at which an image forming unit is driven to form an image on a recording medium that is transported by a transport unit. The delay time information output unit outputs delay time information showing a delay time from the time at which the timing signal is generated to the time at which the image forming unit is driven with delay so that positions of pixels formed by the image forming unit are offset within the range of one pixel with respect to a transport direction. The drive unit drives the image forming unit after the delay time shown by the delay time information.

### CROSS-REFERENCE TO RELATED APPLICATION

This application claims priority under 35 USC 119 from Japanese Patent Application No. 2008-064160, the disclosure of which is incorporated by reference herein.

### BACKGROUND OF THE INVENTION

1. Field of the Invention

The present invention relates to an image processing apparatus, an image forming apparatus, and an image processing method, and more particularly to an image processing apparatus, an image forming apparatus having the image processing apparatus, and an image processing method, which are preferable for image formation processing employing a line system as a scan system.

2. Description of the Related Art

As a structure of an in inkjet head for drawing an image having a higher density, Japanese Patent Application Laid-Open (JP-A) No. 2006-281776 discloses a so-called matrix type head in which nozzles are two-dimensionally disposed.

In such a matrix type head, since the intervals between the pixels of a drawn image may be made smaller than lengths and widths that respective nozzles require, an image having a high density of 600 dpi or more may be drawn. As a result, formation of an image with high fineness and high image quality may be expected.

However, the following new problems can occur in the matrix type head compared to conventional heads.

Since nozzles are disposed over a certain length in a medium transport direction, a head mounting angle error, change in a medium transport speed, and the like are liable to affect unevenness of an image and the like. It has been conventionally attempted to solve the problem by various means.

For example, JP-A No. 2006-315322 discloses technology for offsetting a start position (time) of a heat pulse for each nozzle area to prevent deterioration of an ink landing accuracy caused by inclination, positional offset, and distortion of a head when it is mounted.

Further, JP-A No. 2001-63016 discloses technology for suppressing deterioration of image quality by controlling the disposition of dots for each raster of nozzles (trains adjacent in a medium transport direction) in a pixel unit.

However, the matrix head aims to draw an image having a high density. Accordingly, an image must be drawn with a high density not only in a direction in which nozzles of a head are disposed but also in a medium transport direction.

In general, in an inkjet printer, a medium transport speed and a medium position are accurately detected by an encoder (rotary encoder or the like) and ejection is performed from a head in synchronization with a result of the detection. In order to draw an image with a high density of, for example, 600 dpi or more required for the matrix head, an encoder having a high resolution is necessary; however, this increases the cost.

Further, nozzles are disposed in the matrix head with a certain width in a medium transport direction because of the structure of the matrix head. The width is necessary to secure an area of an ink pressure chamber and may have a length of up to several millimeters (covering several thousands of pixels).

If the encoder erroneously detects a speed, the detection error appears in an image as disturbance of lines in a main scan direction.

When, for example, a head has a density (pixel density) of 1200 dpi, and a head width is 10 mm, and it is intended to restrict the disturbance of the lines to within about 1/10 pixel=2 μm, speed detection error of 0.05% is required. Although it is preferable that the encoder ideally have a resolution equal to the intervals between pixels of a drawn image or greater, a high accuracy encoder is expensive, and further it is difficult to measure a speed by an encoder without any error because there is error in the mounting of the encoder and the like.

Since such error is not constant and may be variable, the error may not be corrected by a simple and fixed adjustment as in the technology disclosed in JP-A No. 2006-315322.

Further, the matrix head has such a structure that nozzles are repeatedly disposed over a predetermined cycle (every 30 to 60 pixels or the like). Since disturbance due to the error has a cycle of, for example, (every 30 to 60 pixels)= 1/1200 dpi×(30 to 60 pixels)=(0.5 to 1 mm), the disturbance is visually conspicuous. Accordingly, even a minute amount of offset deteriorates image quality.

In contrast, even if the technology disclosed in JP-A No. 2001-63016 is used, since correction is performed in a unit of one pixel, it may not be said that the correction is performed sufficiently, and a processing time is increased by the correction because image data is processed.

Even if an encoder for accurately detecting a change in a transport speed is used, it is difficult for the encoder to perfectly cope with the change in the transport speed. Further, since an encoder for accurately detecting the transport speed is expensive as described above, a cost of an apparatus increases.

As described above, the conventional technologies have a problem in that they may not suppress disturbance of an image due to the change in a transport speed of a recording medium.

### SUMMARY OF THE INVENTION

The present invention has been made in view of the above circumstances and provides an image processing apparatus and an image processing method.

A first aspect of the present invention provides an image processing apparatus includes a timing signal generation unit, a delay time information output unit, and a drive unit. The timing signal generation unit generates a timing signal showing timing at which an image forming unit is driven to form an image on a recording medium that is transported by a transport unit that transports the recording medium on which the image is to be formed. The delay time information output unit outputs, when the timing signal is generated by the timing signal generation unit, delay time information showing a delay time from the time at which the timing signal is generated to the time at which the image forming unit is driven with delay so that positions of pixels formed by the image forming unit are offset within the range of one pixel with respect to a transport direction, as compared with positions of pixels which are formed when the image forming unit is driven at the time the timing signal is generated. The drive unit drives the image forming unit after the delay time shown by the delay time information that is output by the delay time information output unit elapses.

A second aspect of the present invention provides an image processing method includes generating a timing signal showing timing at which an image forming unit is driven to form an image on a recording medium that is transported by a transport unit that transports the recording medium on which the image is to be formed, outputting, when the timing signal is generated, delay time information showing a delay time from the time at which the timing signal is generated to the time at which the image forming unit is driven with delay so that positions of pixels formed by the image forming unit are offset within the range of one pixel with respect to a transport direction, as compared with positions of pixels which are formed when the image forming unit is driven at the time the timing signal is generated, and driving the image forming unit after the delay time shown by the output delay time information elapses.

### BRIEF DESCRIPTION OF THE DRAWINGS

FIG. 1 shows an example of an overall view of a structure of an inkjet recording apparatus according to an exemplary embodiment;

FIG. 2 is a plan view of a main portion of the inkjet recording apparatus in the periphery of a print unit thereof;

FIG. 3 is a perspective plan view showing an example of a structure of a head;

FIG. 4 is an enlarged view of the example of the structure of the head in which a part of the head is enlarged;

FIG. 5 is a cross-sectional view showing a three-dimensional structure of a droplet ejection device;

FIG. 6 is a view showing an arrangement of nozzles of the head;

FIG. 7 is a block diagram showing an example of a system structure of the inkjet recording apparatus;

FIG. 8 is a view showing a detailed structure relating to the exemplary embodiment of the structure of the inkjet recording apparatus;

FIG. 9 is a view showing an example of a configuration of a delay controller;

FIG. 10 is a view showing another configuration of the delay controller;

FIG. 11 is a view showing a range in which pixels exist when a delay occurs;

FIG. 12 is a view showing an example of an arrangement of nozzles used in the exemplary embodiment;

FIGS. 13A to 13C are views showing examples of offsets caused when a transport speed changes;

FIG. 14 is a view showing an example of a waveform output by being delayed from the timing shown by an ejection reference timing signal;

FIGS. 15A and 15B are views showing an example of images formed by the structure according to the exemplary embodiment;

FIG. 16 is a flowchart showing image processing according to the exemplary embodiment;

FIG. 17 is a view showing a structure of a modification example; and

FIG. 18 is a view showing an example of a waveform in the modification example.

### DETAILED DESCRIPTION OF THE INVENTION

An exemplary embodiment of the present invention is explained below in detail referring to the drawings.

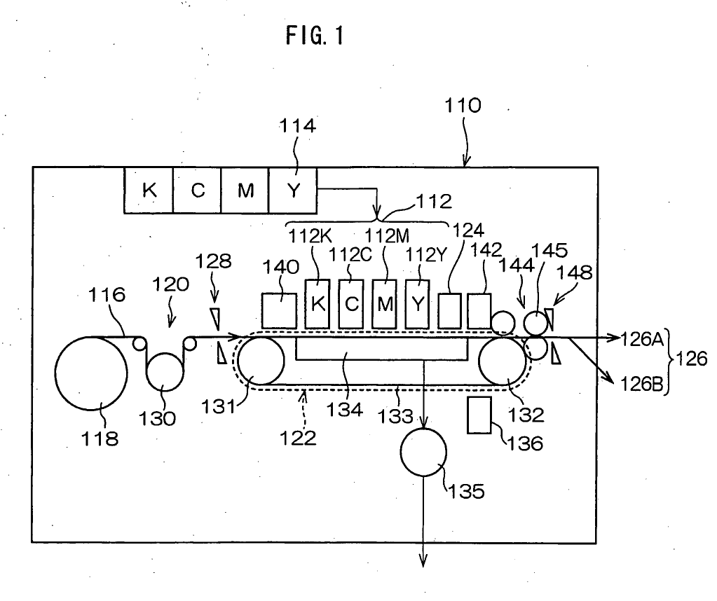

FIG. 1 is an overall view of a structure of an inkjet recording apparatus showing an exemplary embodiment of an image forming apparatus according to the invention. As shown in the drawing, the inkjet recording apparatus 110 has a print unit 112 including a plurality of inkjet recording heads (hereinafter, referred to as “heads”) 112K, 112C, 112M, 112Y disposed corresponding to respective black (K), cyan (C), magenta (M), and yellow (Y) inks, an ink storage/loading unit 114 for storing the inks supplied to the respective heads 112K, 112C, 112M, 112Y, a paper feed unit 118 for supplying printing paper 116 as a recording medium, a decurl processing unit 120 for removing curl of the printing paper 116, a belt transport unit 122 disposed opposite to a nozzle surface (ink ejection surface) of the print unit 112 for transporting the printing paper 116 while keeping the paper flat, a print detection unit 124 for reading a result of printing executed by the print unit 112, and a paper discharge unit 126 for discharging printing paper (printed matter), on which printing has been completed, to the outside. Note that the term “print” used in the specification includes printing of an image in addition to printing of characters.

The ink storage/loading unit 114 has ink tanks for storing color inks corresponding to the respective heads 112K, 112C, 112M, 112Y, and the respective ink tanks communicate with the heads 112K, 112C, 112M, 112Y through necessary pipe paths. Further, the ink storage/loading unit 114 has a notification unit for notifying that ink remaining amounts are reduced, and a mechanism for preventing that the ink tanks are erroneously loaded to different colors.

Although FIG. 1 shows a magazine of roll paper (continuous paper) as an example of the paper feed unit 118, a plurality of magazines of paper having a different paper widths, paper quality, and the like may be provided. Further, paper may be supplied from a cassette in which cut paper are stacked together with or in place of the magazine of the roll paper.

When the inkjet recording apparatus is arranged such that it may use a plurality types of recording media, it is preferable that a type of a recording medium to be used is automatically discriminated and an ink ejection control is performed to eject inks appropriately according to the medium type in such a manner that an information recording medium such as a bar code, an RFID tag, or the like, to which medium type information is recorded, is attached to magazines and the information of the information recording medium is read by a predetermined reading device.

The printing paper 116 fed from the paper feed unit 118 curls because a curl tendency due to being mounted in the magazine remains. In order to remove the curl, the decurl processing unit 120 applies heat to the printing paper 116 with a heat drum 130 in a direction opposite to the direction in which it is curled in the magazine. At this time, it is preferable to control a heating temperature so that a printed surface has a weak curl towards the outside.

When the apparatus is arranged to use roll paper, as shown in FIG. 1, the apparatus is provided with a cutter 128 for cutting, and the roll paper is cut to a desired size by the cutter 128. Note that when cut paper are used, the cutter 128 is not necessary.

After the decurl processing is executed, the cut printing paper 116 is fed to the belt transport unit 122. The belt transport unit 122 has such a structure that an endless belt 133 is wound between rollers 131, 132.

The belt 133 has a width larger than that of the printing paper 116, and a lot of suction holes (not shown) are formed on a belt surface. As shown in the drawing, a suction chamber 134 is disposed at an opposite position of the nozzle surface of the print unit 112 and a sensor surface of the print detection unit 124 at the inside of the belt 133 trained between the rollers 131, 132, and the printing paper 116 is absorbed and held on the belt 133 by sucking the suction chamber 134 with a fan 135 and applying negative pressure thereto. Note that an electrostatic absorbing system may be employed in place of the suction/absorption system.

Since power is transmitted to at least one of the rollers 131, 132 around which the belt 133 is wound from a not shown motor, the belt 133 is driven clockwise of FIG. 1 and the printing paper 116 held on the belt 133 is transported from left to right of FIG. 1.

When edgeless printing and the like are performed, since ink is deposited also on the belt 133, a belt cleaning unit 136 is disposed at a predetermined position outside of the belt 133 (appropriate position other than a print region). Although a structure of the belt cleaning unit 136 is not shown in detail, for example, a system for nipping a brush roll, a water absorbing roll, and the like, an air blow system for blowing air, a combination of these systems, and the like are employed. In the system for nipping the cleaning roll, a cleaning effect is improved when a belt line speed is set to a speed different from a roller line speed.

Note that although a mode in which a roller/nip transport mechanism is used in place of the belt transport unit 122 may be considered, when paper is transported on the print region by roller/nip transport mechanism, a problem arises in that an image is liable to blur because a print surface of the paper comes into contact with the roller just after printing is performed thereon. Accordingly, it is preferable to transport paper by the absorption belt which does not cause an image surface to come into contact with the belt in the print region.

A heat fan 140 is disposed upstream of the print unit 112 on a paper transport path formed by the belt transport unit 122. The heat fan 140 blows hot air to the printing paper 116 before printing is performed thereto so that the printing paper 116 is heated. Ink may be easily dried after it lands on the printing paper 116 by heating it just before the printing is performed.

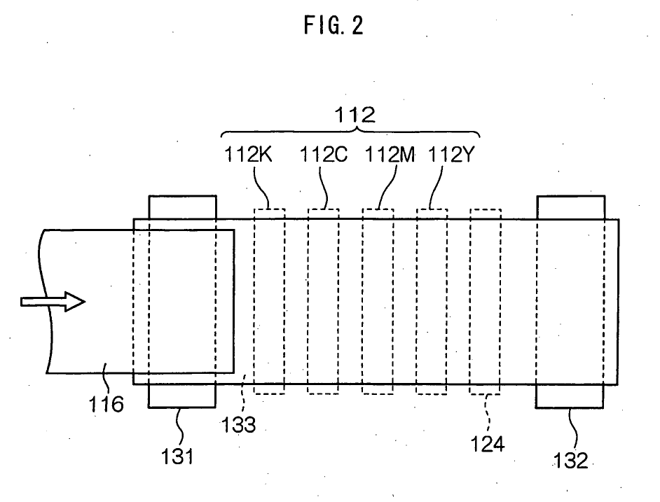

The respective heads 112K, 112C, 112M, 112Y of the print unit 112 are structured as such full line type heads having lengths corresponding to the maximum paper width of the printing paper 116 treated by the inkjet recording apparatus 110, and a plurality of ink ejection nozzles are disposed on nozzles surfaces of the respective heads over a length exceeding at least one side of the printing paper 116 having a maximum size (entire width of drawing possible range, refer to FIG. 2).

The heads 112K, 112C, 112M, 112Y are sequentially disposed along a feed direction of the printing paper 116 from upstream thereof in the order of black (K), cyan (C), magenta (M), and yellow (Y) and fixed so that they extend along a direction approximately orthogonal to the transport direction of the printing paper 116.

A color image may be formed on the printing paper 116 by ejecting different color inks from the respective heads 112K, 112C, 112M, 112Y while transporting the printing paper 116 by the belt transport unit 122.

According to the structure in which the full line type heads 112K, 112C, 112M, 112Y each having a nozzle train covering an entire paper width region are disposed for respective colors as described above, an image may be recorded on the entire surface of the printing paper 116 by executing an operation for moving the printing paper 116 relative to the print unit 112 in a paper feed direction (sub-scan direction) only once (i.e., by executing sub-scan only once). With this operation, high-speed printing may be performed as compared with a shuttle type head in which a recording head reciprocatingly move in a direction orthogonal to a paper transport direction and thus productivity may be improved.

Although the exemplary embodiment exemplifies a structure using standard KCMY colors (four colors), a combination of ink colors and a combination of the number of colors are not limited to the exemplary embodiment and light ink, deep ink, and special color ink may be added as necessary. It is possible to employ, for example, a structure to which an inkjet head for ejecting light inks such as light cyan, light magenta, and the like is added. Further, the order in which the respective color heads are disposed is not particularly limited.

The print detection unit 124 shown in FIG. 1 includes an image sensor (line sensor or the area sensor) for picking up an image of a result of ejection of ink droplets executed by the print unit 112, and has a function as a means for checking ejection characteristics such as clogging of nozzles, landing position error, and the like from an image of ink droplets picked up by the image sensor.

A CCD area sensor, in which a plurality of light receiving devices (photoelectric conversion devices) are two-dimensionally disposed on a light receiving surface, may be preferably used to the print detection unit 124 of the exemplary embodiment. It is assumed that the area sensor has at least an image pickup range in which it may pick up an image in the entire region of the width to which inks are ejected by the respective heads 112K, 112C, 112M, 112Y (image recording width). An image pick-up in a necessary image pickup range may be performed by one area sensor or performed by combining (connecting) a plurality of area sensors. Otherwise, it is also possible to perform the image pick-up in the necessary image pickup range by supporting an area sensor by a moving mechanism (not shown) and moving (scanning) the area sensor.

Further, a line sensor may be used in place of the area sensor. In this case, the line sensor is preferably arranged such that it has a light receiving device train (photoelectric conversion device train) wider than at least that of an ink ejection width (image record width) of the inks ejected by the heads 112K, 112C, 112M, 112Y.

As described above, the print detection unit 124 is a block including the image sensor and reads an image printed on the printing paper 116, detects a print status (presence or absence of ejection, landing position error, dot shape, optical density, and the like) by performing necessary signal processing, and provides a print controller 180 and a system controller 172 with a result of detection.

A rear drying unit 142 is disposed downstream of the print detection unit 124. The rear drying unit 142 dries a printed image surface, and for example, a heat fan is employed. A system for blowing hot air is preferably used because it is preferable to prevent contact of a printed surface until ink is dried after printing is performed.

When porous paper is printed by dye ink, weather resistance of an image may be enhanced by preventing the dye ink from coming into contact with substances such as ozone and the like because they break dye molecules by clogging the holes of the porous paper.

A heating/pressurizing unit 144 is disposed downstream of the rear drying unit 142. The heating/pressurizing unit 144 is a means for controlling glossiness of an image surface and transfers a concave/convex shape onto an image surface by pressing it by a pressure roller 145 having a predetermined concave/convex shape while heating the image surface.

A printed matter made as such the manner is discharged from the paper discharge unit 126. It is preferable to separately discharge a printed matter on which a final image is printed (printed matter on which a target image is printed) and a printed matter on which an image is printed as a test. The inkjet recording apparatus 110 is provided with a not-shown selection unit for switching discharge paths to select the printed matter on which the final image is printed and the printed matter on which the image is printed as the test, and to feed them to respective discharge units 126A, 126B.

Note that when the final image and the test image are formed on large paper side by side at the same time, the portion of the test print is cut off by a cutter 148. Further, although not shown in the drawing, a sorter is disposed to the discharge unit 126A of the final image to collect images by classifying them to respective orders.

Next, a structure of the head is explained. It is assumed that since the respective heads 112K, 112C, 112M, 112Y of the respective colors have the same structure, a head representing these heads is denoted by reference numeral 150.

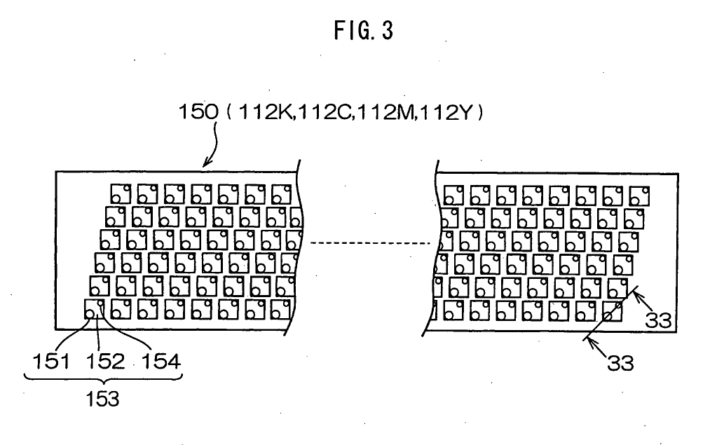

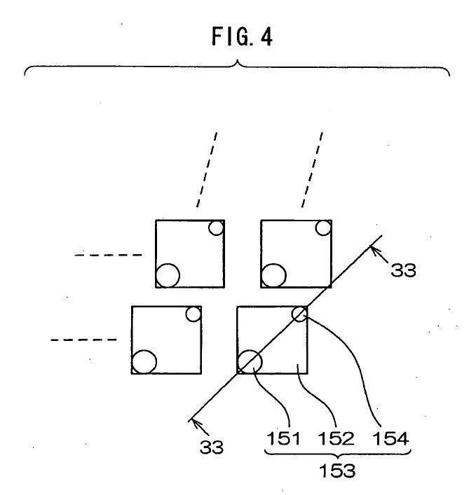

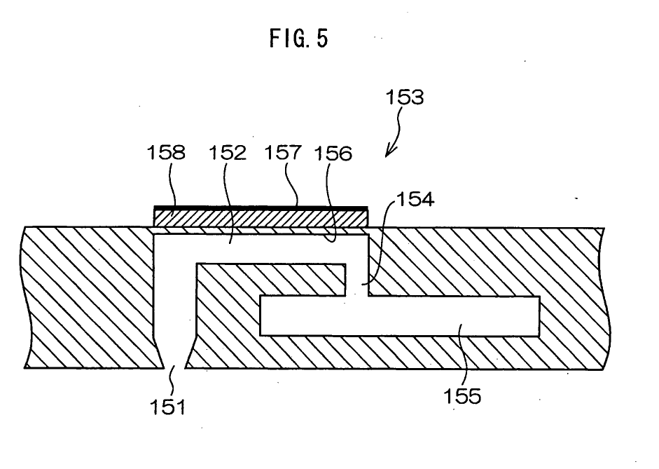

FIG. 3 is a perspective plane view showing an example of the structure of the head 150, and FIG. 4 is an enlarged view of a part of the head 150. Further, FIG. 5 is a cross-sectional view (cross-sectional view along line 33-33 in FIG. 4) showing a three-dimensional structure of one droplet ejection device (ink chamber unit corresponding to one nozzle 151).

It is necessary to increase nozzle pitches in the head 150 to increase the density of the pitches of dots printed on the printing paper 116. As shown in FIGS. 3 and 4, the head 150 has such a structure that a plurality of ink chamber units (droplet ejection devices) 153, each of which is composed of the nozzle 151 as an ink ejection port, a pressure chamber 152 corresponding to the nozzle 151, and the like, are disposed zigzag in a matrix state (two-dimensionally). With this arrangement, the density of substantial nozzles intervals (projected nozzles pitches), which are projected so that they are arranged side by side in a head longitudinal direction (direction orthogonal to a paper feed direction), is increased.

Note that a mode for arranging one or more nozzle train over a length corresponding to the entire width of the printing paper 116 in a direction approximately orthogonal to the feed direction of the printing paper 116 is not limited to the exemplary embodiment.

The pressure chamber 152, which is disposed in correspondence to each nozzle 151, is formed in an approximately square plane shape (refer to FIGS. 3 and 4) and has an outlet port to the nozzle 151 formed at one of the both corners on a diagonal line and an inlet port (supply port) 154 of ink supplied thereto at the other of the corners. Note that the plane shape of the pressure chamber 152 is not limited to the exemplary embodiment and may be formed in various shapes such as a square shape (diamond shape, rectangular shape, and the like), pentagon shape, hexagonal shape, other polygonal shape, circular shape, oval shape, and the like.

As shown in FIG. 5, the respective pressure chambers 152 communicate with a common flow path 155 through the supply ports 154. The common flow path 155 communicates with ink tanks (not shown) which are ink supply sources, and the inks supplied from the ink tanks are supplied to the respective pressure chambers 152 through the common flow path 155.

An actuator 158 having an individual electrode 157 is joined to a pressure plate (vibration plate used also as a common electrode) 156 which forms a part of the surface of the pressure chamber 152 (top surface in FIG. 5). The actuator 158 is deformed and the volume of the pressure chamber 152 is changed by applying a drive voltage between the individual electrode 157 and the common electrode, and ink is ejected from the nozzle 151 by a pressure change caused by the change of the volume. Note that a piezoelectric device using a piezoelectric member composed of lead zirconate titanate, barium titanate, and the like is preferably used for the actuator 158. When the deformed actuator 158 returns to its original shape after the ink is ejected, the pressure chamber 152 is filled with new ink again from the common flow path 155 through the supply port 154.

Ink droplets may be ejected from the nozzles 151 by controlling the driving of the actuators 158 corresponding to the respective nozzles 151 according to dot disposition data created from image information. As explained in FIG. 1, a desired image may be recorded on the printing paper 116 as a recording medium by transporting it in the sub-scan direction at a predetermined speed and controlling timings at which inks are ejected from the respective nozzles 151 to match the transport speed of the printing paper 116.

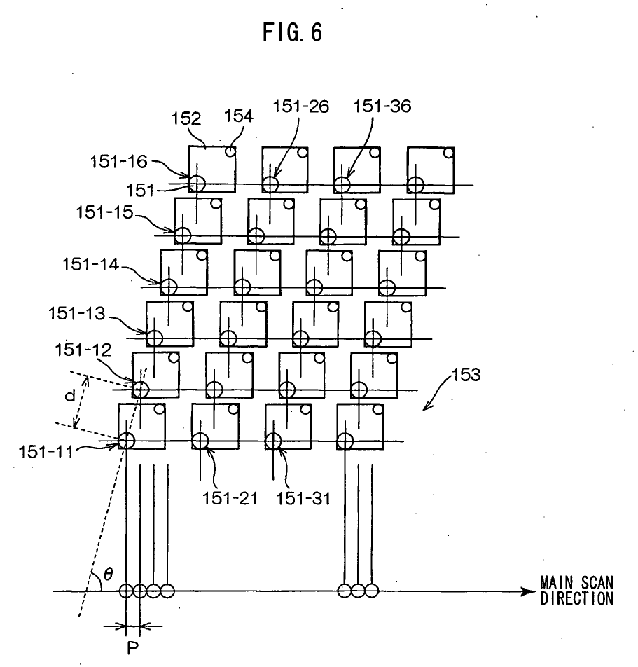

A high density nozzle head of the exemplary embodiment may be realized by disposing plural ink chamber units 153 having the structure described above in a predetermined disposition pattern in a lattice shape in a row direction along a main scan direction, and along an oblique column direction which is not orthogonal to the main scan direction and has a predetermined angle θ as shown in FIG. 6.

More specifically, since the plurality of ink chamber units 153 are disposed along the direction having the angle θ to the main scan direction at a predetermined pitch d, a pitch P of the projected nozzles which are arranged in the main scan direction is expressed as d×cos θ. Thus, in the main scan direction, it can be assumed that the respective nozzles 151 are disposed linearly at the predetermined pitch P. With this arrangement, a high density nozzle arrangement may be realized, in which 2400 nozzle trains per inch (2400 nozzles/inch) are projected so that the nozzle trains are arranged in the main scan direction.

It is defined as a sub-scan to repeatedly execute printing of one line (line composed of dots of one column or dots of a plurality of columns) formed by the main scan described above by moving the full line head described above relative to paper.

The direction shown by the one line (or a longitudinal direction in a band-shaped region) recorded by the main scan described above is called the main scan direction, and the direction in which the sub-scan described above is executed is called the sub-scan direction. More specifically, in the exemplary embodiment, the transport direction of the printing paper 116 is the sub-scan direction, and the direction orthogonal to the sub-scan direction is the main scan direction.

When the invention is embodied, the structure in which the nozzles are disposed is not limited to the illustrated example. The exemplary embodiment employs a system for flying ink droplets by deforming the actuator 158 represented by the piezo device (piezoelectric device). However, when the invention is embodied, the system for ejecting ink is not particularly limited and various systems such as a thermal jet system for generating bubbles by heating ink by a heating element and flying ink droplets by the pressure of the bubbles, and the like may be applied in place of the piezo jet system.

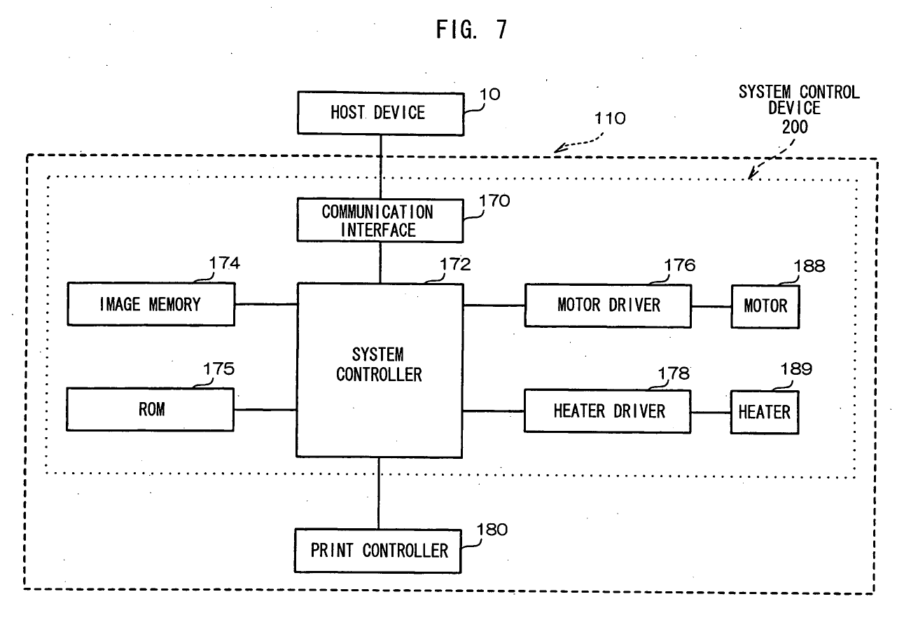

FIG. 7 is a block diagram showing a system structure of the inkjet recording apparatus 110. As shown in FIG. 7, the inkjet recording apparatus 110 is roughly composed of a system control device 200 and a print controller 180.

A system control device 200 has a communication interface 170, a system controller 172, an image memory 174, a ROM 175, a motor driver 176, a heater driver 178, and the like.

The communication interface 170 is an interface unit to a host device 10 used for user to instruct printing to the inkjet recording apparatus 110. A serial interface such as USB (Universal Serial Bus), IEEE 1394, Ethernet (registered trademark), a wireless network, and the like and a parallel interface such as Centronics may be applied to the communication interface 170. The above components may be mounted on a buffer memory (not shown) in order to increase a communication speed.

The image information supplied from the host device 10 is captured by the inkjet recording apparatus 110 through the communication interface 170 and stored to the image memory 174 once. The image memory 174 is a memory unit for storing the image input through the communication interface 170, and data is written to and read from it through the system controller 172. The image memory 174 is not limited to a memory composed of a semiconductor device, and a magnetic medium such as a hard disc may be used.

The system controller 172 is formed from a central processing unit (CPU) and its peripheral circuit and the like, and functions as a controller for controlling the entire inkjet recording apparatus 110 and as a calculation unit for executing various calculations. More specifically, the system controller 172 controls the respective units such as the communication interface 170, the image memory 174, the motor driver 176, the heater driver 178, the print controller 180, and controls a communication of the host device 10 and reading from and writing to the image memory 174 and the ROM 175. Additionally, the system controller 172 generates a control signal for controlling a motor 188 and a heater 189 of a transport system. Note that the image information stored to the image memory 174 is transmitted to the print controller 180 in addition to the control signal. Further, the system controller 172 may also create the data of landing position error, the data of a dot shape from the data read from the print detection unit 124.

Further, the ROM 175 stores various types of data necessary for the program and the control which is executed by the CPU of the system controller 172. Although the ROM 175 is a non-rewritable memory unit, when the various types of the data are updated as necessary, a rewritable memory unit such as EEPROM is preferably used as the ROM 175.

The image memory 174 is used as a temporary memory region of the image information and also as a region for developing the program as well as a calculation job region of the CPU.

The motor driver 176 is a driver (drive circuit) for driving the motor 188 of the transport system in response to an instruction from the system controller 172. The heater driver 178 is a driver for driving a heater 189 of the rear drying unit 142 in response to an instruction from the system controller 172.

The print controller 180 functions as a signal processing unit for performing such as various processing or corrections for creating an ejection control signal from the image information transmitted from the system control device 200 under the control of the system controller 172. The print controller 180 also controls the ejection from the head 150 based on the ink ejection data created thereby.

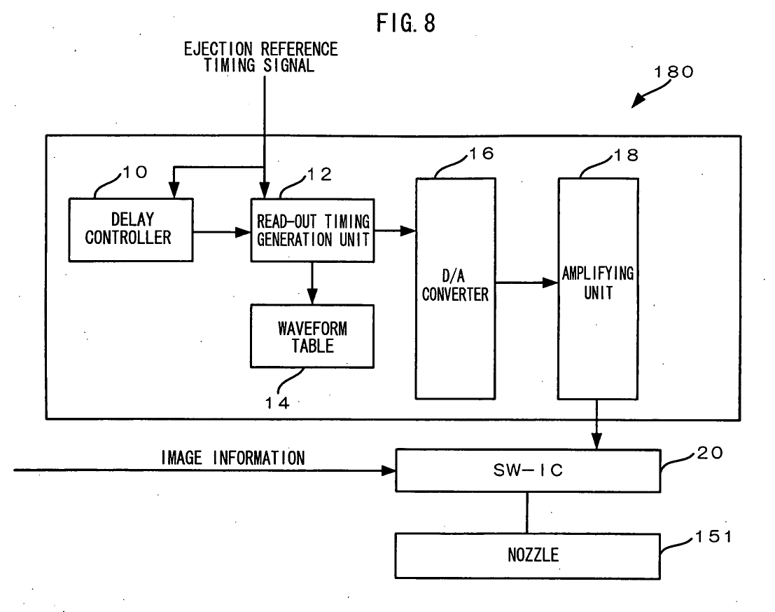

Next, a structure relating to the exemplary embodiment of the structure of the inkjet recording apparatus 110 described above is explained in detail using FIG. 8.

FIG. 8 shows a part of the print controller 180 in detail. As shown in FIG. 8, the print controller 180 is input with an ejection reference timing signal (timing signal) and the image information from the system control device 200.

The ejection reference timing signal is generated by an encoder for detecting the transport speed and the position of the recording medium from the roller 131 or 132. The encoder generates a timing signal showing timing at which the nozzles 151 are driven to form an image on the recording medium transported by the roller 131 or 132. Accordingly, the ejection reference timing signal shows timing to match the transport speed at which the recording medium is transported by the rollers 131, 132.

As shown in the drawing, a delay controller 10, a read-out timing generation unit 12, a waveform table 14, a D/A converter 16, an amplifying unit 18, an SW-IC 20, and the nozzles 151 described above are shown in the print controller 180.

In the delay controller 10, a generated ejection reference timing signal is input. The delay controller 10 delays timing at which the read-out timing generation unit 12 is started up. Specifically, when the ejection reference timing signal is generated by the encoder, the delay controller 10 outputs delay time information showing a delay time until the nozzles 151 are driven after they are delayed from the time at which the ejection reference timing signal is generated, so that the pixels formed by the nozzles 151 are offset within the range of one pixel with respect to the transport direction as compared with the positions of the pixels which are formed by the nozzles 151 when the timing signal is generated.

The read-out timing generation unit 12 reads out a waveform from the waveform table 14 by delaying read-out timing based on the delay time information output from the delay controller 10 and outputs the waveform to the D/A converter 16.

The waveform table records waveform data corresponding to the types of inks to be ejected such as a large drop, a small drop, and the like.

The D/A converter 16 converts the waveform data as a digital signal which is output from the read-out timing generation unit 12 to an analog signal. The amplifying unit 18 power amplifies the waveform data as the analog signal.

The SW-IC 20 supplies the waveform data to the nozzles 151 according to the image information. Further, the nozzles 151 are shown assuming that they include piezo devices described above, and the signal output from the SW-IC 20 is supplied to the piezo devices.

The read-out timing generation unit 12, the D/A converter 16, and the SW-IC 20 described above drive the nozzles 151 after the delay time shown by the delay time information output by the delay controller 10 elapses.

A flow according to the above structure is such that when the ejection reference timing signal is input first, the waveform data is read out from the waveform table 14 by the read-out timing generation unit 12 and transferred to the D/A converter 16. The waveform data is converted to an analog voltage by the D/A converter 16, power-amplified by the amplifying unit 18, and supplied to the piezo devices described above through the SW-IC 20, and an image is formed on the recording medium by driving the piezo devices.

Note that since the nozzles 151 are an image forming unit, the arrangement obtained by excluding the nozzles 151 from the inkjet recording apparatus 110 shown in FIG. 1 is an image processing apparatus.

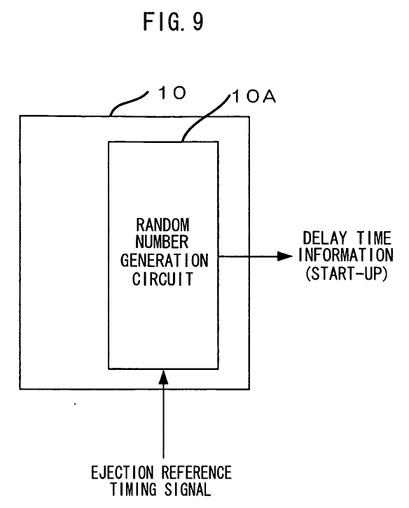

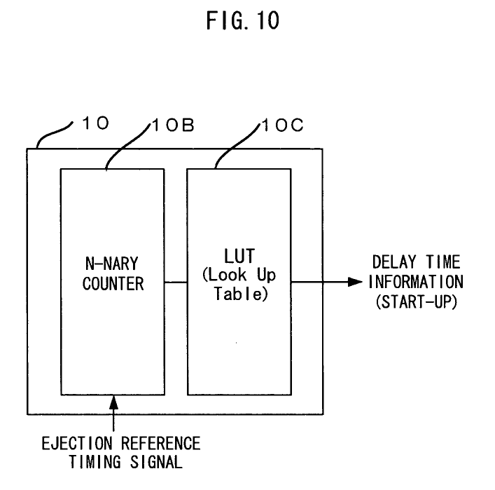

Next, an example of a structure of the delay controller 10 is explained using FIGS. 9 and 10. As shown in FIG. 9, the delay controller 10 has a random number generation circuit 10A. When the ejection reference timing signal described above is input to the random number generation circuit 10A, the random number generation circuit 10A generates a random number. The read-out timing generation unit 12 is started up by outputting delay time information based on the random number.

Further, the delay controller 10 generates a new random number each time the ejection reference timing signal is generated. With this operation, since a delay time is output based on a new random number each time the ejection reference timing signal is generated, regularly-dotted pixels which have a high possibility that they are visually recognized may be prevented from being offset.

In contrast, the delay controller 10 shown in FIG. 10 includes a N-nary counter 10B and a LUT (Look Up Table) 10C. The LUT 10C stores the delay time information showing a plurality of predetermined delay times. The N-nary counter counts the number of times the ejection reference timing signal is input. Based on the count number, the delay time information from the LUT 10C is selected, and then the selected delay time information is output. More specifically, the delay controller 10 outputs the delay time information based on a plurality of pieces of the delay time information stored by the LUT 10C. In this case, the plurality of pieces of delay time information is repeatedly output using the size of the LUT 10C as a repetition cycle. Although the size of the table is determined by the size of a memory of the LUT 10C, it is easy to provide a repetition cycle of several thousands to several tens of thousands of ejections.

Note that when an image itself has a cycle property such as network points, it is possible to suppress interference with the network points by previously setting the delay time information to the LUT 10C so that a delay time changes in a cycle different from the value of the cycle of the network points.

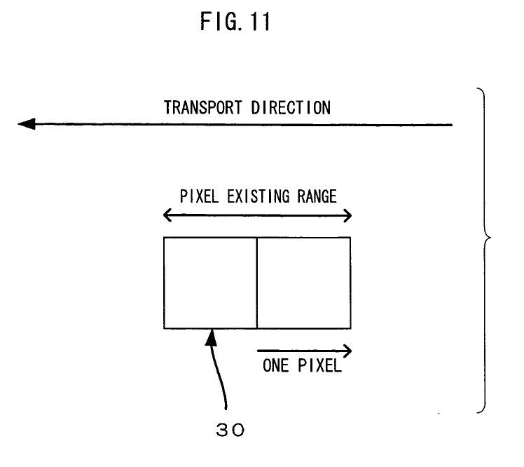

In any cases, the delay time information shows a delay time during which pixels are offset in the range of one pixel to the transport direction. This is specifically explained using FIG. 11. As described above, when there is no output from the delay controller 10, a pixel is formed based on the ejection reference timing signal created by the encoder for detecting the transport speed and the position of the recording medium.

When the pixel which is formed based on the ejection reference timing signal is shown by a pixel 30, an amount of offset is set in the range of one pixel behind the pixel 30 in the transport direction (in a pixel existing range in FIG. 11). With the above structure, even if a pixel is formed using a random number, it is not outstandingly offset, and an image may be suppressed from being disturbed by the change in the transport speed.

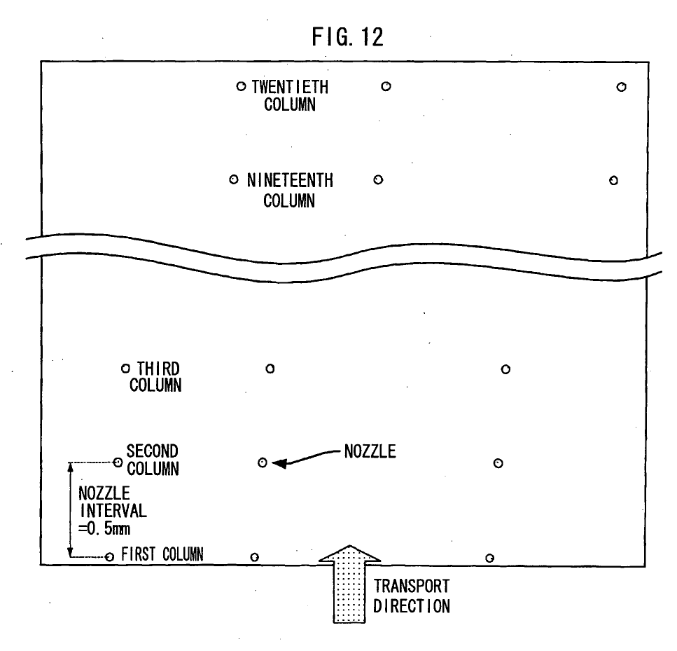

An example of disposition of the nozzles 151 used in the exemplary embodiment is explained using FIG. 12. FIG. 12 shows the disposition of the nozzles explained in FIG. 3 in more detail, and the disposition is schematically shown by a head having four nozzles disposed repeatedly in order to make the figure more understandable.

In FIG. 12, patterns shown by small circles show the nozzles which are disposed to 20 columns in the sub-scan direction with each column set at an interval of 0.5 mm to secure a resolution of drawing of 1200 dpi. Note that nozzles from a fourth column to eighteenth column are omitted in FIG. 12. Although not shown in the drawing, the piezo devices are disposed to the nozzles 151 in one-to-one as described above, and ink is ejected by electrically driving the piezo device.

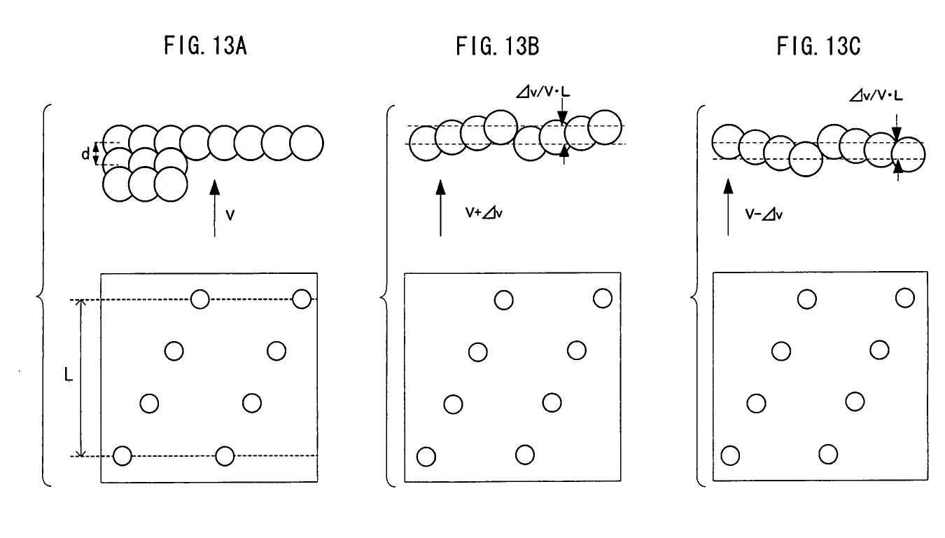

Examples of offset of pixels caused by the change in the transport speed when the nozzles 151 are disposed as shown in FIG. 12 is explained using FIG. 13.

FIG. 13A shows an example of an image which is formed when dots are not offset. FIG. 13B shows an example of an image which is formed when an actual transport speed is faster than the transport speed detected by the encoder. FIG. 13C shows an example of an image which is formed when an actual transport speed is slower than the transport speed detected by the encoder. Further, the distance from a first column to a fourth column set to L in FIG. 13.

In FIG. 13B, a dot formed by a nozzle 151 from which ink is ejected later is more offset. When it is assumed that the actual transport speed is faster than the detected transport speed V by Δv, the width of offset of the dot is shown by (Δv/V)×L.

In contrast, in FIG. 13C, it may be found that a dot formed by a nozzle 151 from which ink is ejected earlier is more offset. When it is assumed that the actual transport speed is slower than the detected transport speed V by Δv, the width of offset of the dot is shown by (Δv/V)×L likewise the above case.

Since the speed of the recording medium is mechanically changed, the speed is changed mainly by a frequency of several Hertz to several hundreds of Hertz, whereas ink droplets are ordinarily ejected at a high frequency of 10 KHz to 50 KHz (frequency of the ejection reference timing signal). Accordingly, the speed is set to an approximately predetermined speed and the image is offset in a predetermined amount in the range shown in FIG. 13. As a result, when dots are offset over a long distance in the transport direction of the recording medium as shown in FIGS. 13B and 13C, they are liable to be visually recognized as irregular images and thus liable to be recognized as image defects.

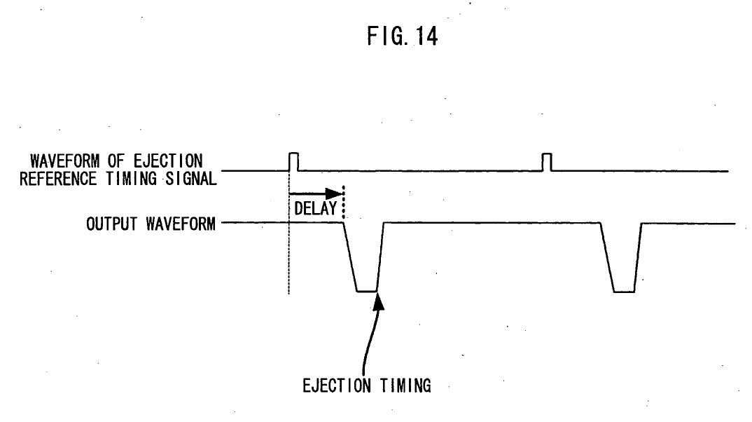

Next, an example of a waveform which is output when it is delayed from the timing shown by the ejection reference timing signal using FIG. 14.

FIG. 14 shows a waveform of the ejection reference timing signal and an output waveform. When the ejection reference timing signal rises in a case that the exemplary embodiment is not applied, the output waveform also rises instantly. However, a delayed output waveform rises due to the delay caused by the delay controller 10 described above as shown in the drawing, and ejection timing is reached thereafter.

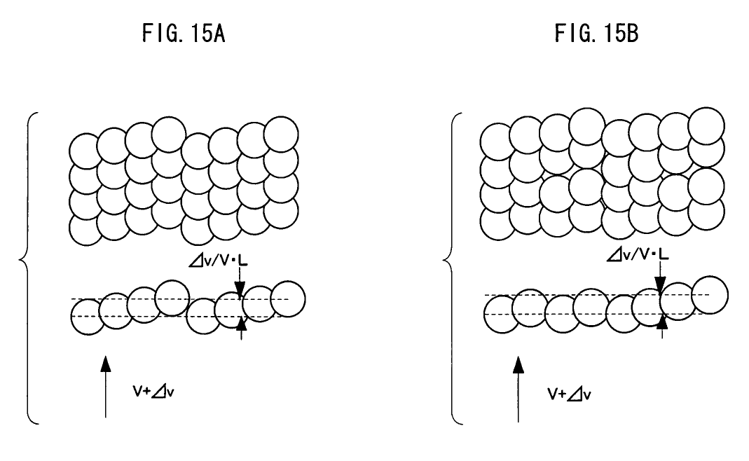

Examples of images formed by the structure of the exemplary embodiment is explained using FIGS. 15A and 15B. FIG. 15A is the same as FIG. 13B, and FIG. 15B shows an example of an image formed by the structure of the exemplary embodiment. When the detected speed of the recording medium has no error, the images are disposed on a perfect lattice as shown in FIG. 13A. However, when the detected speed has error, the image is liable to be visually recognized as the irregular image as described above and is thus liable to be recognized as the image defect.

In contrast, in FIG. 15B showing an example of an image formed by the structure of the exemplary embodiment, it may be found that since the amounts of offset of dots are not uniform, it seems that the dots are not outstandingly offset although the amounts of offset of the dots are partly increased because each sub-scanned dot has a different amount of offset.

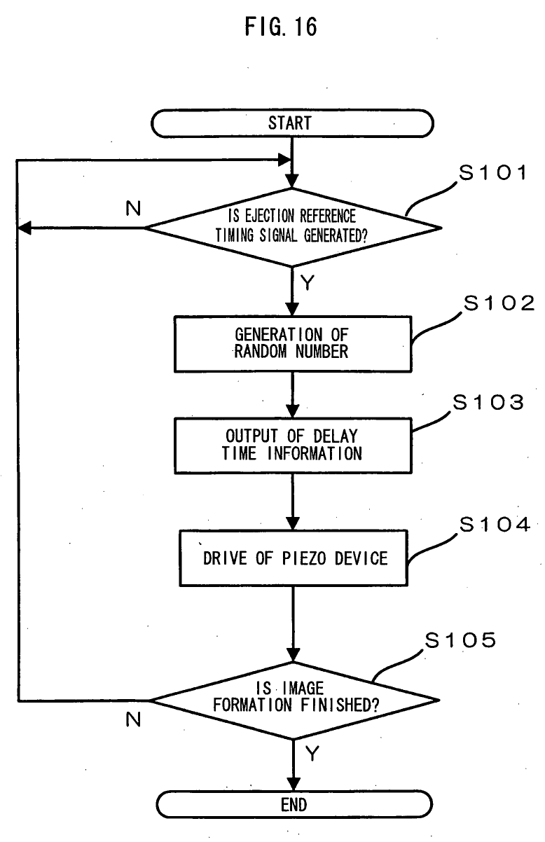

A flow of the processing explained above is explained using a flowchart of FIG. 16. When the ejection reference timing signal is generated at step 101, the delay controller 10 generates a random number at step 102 and outputs the delay time information showing a delay time based on the random number at step 103. When the LUT 110C shown in FIG. 10 is used, delay time information is selected from the LUT 10C based on a counter value, and the selected delay time information is output.

With this operation, the read-out timing generation unit 12 reads out waveform data from the waveform table 14 and transfers the waveform to the D/A converter 16. The waveform data is converted to an analog voltage by the D/A converter 16, power-amplified by the amplifying unit 18, and supplied to the piezo devices described above through the SW-IC 20, and an image is formed on the recording medium by driving the piezo devices at step 104.

Whether or not all the images are formed are determined at next step 105, and when it is determined that all the images are formed, the processing is finished, whereas when it is determined that all the images are not formed, the flow returns to the processing at step 101 again.

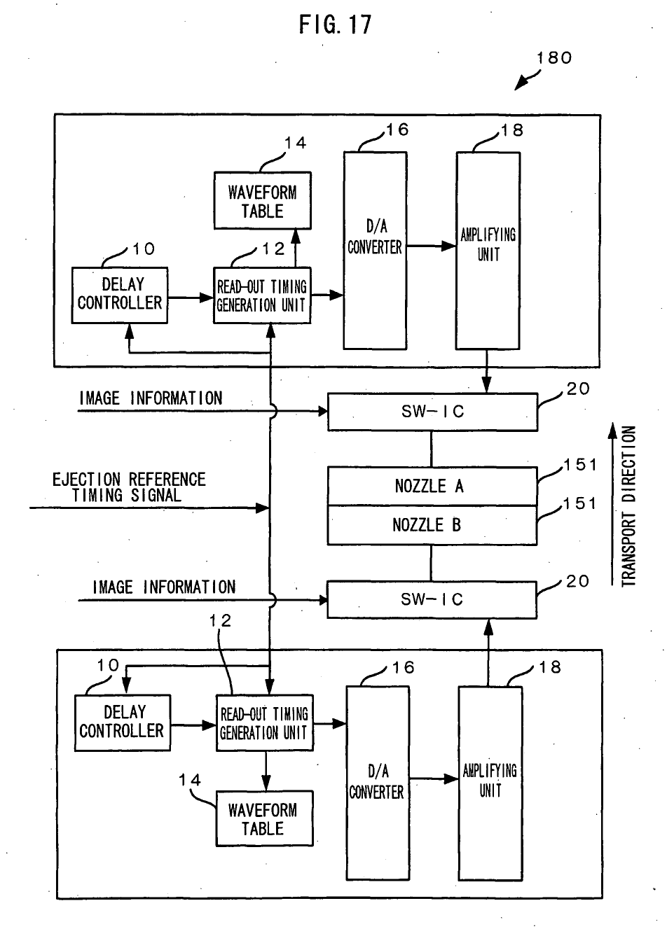

FIG. 17 shows a modification of the exemplary embodiment explained above. An structure shown in FIG. 17 shows an exemplary embodiment when nozzles are disposed in the transport direction of the recording medium. Since the structure is constructed by disposing two sets of the structures shown in FIG. 8, the same blocks are denoted by the same reference numerals as those of FIG. 8 except that nozzles are discriminated by A and B.

As shown in the drawing, the ejection reference timing signal is input to read-out timing generation units 12 and delay controllers 10, and image information is also input to SW-ICs 20. Since the two sets of the delay controllers 10 are disposed, there is a large possibility that two pieces of delay time information are different from each other.

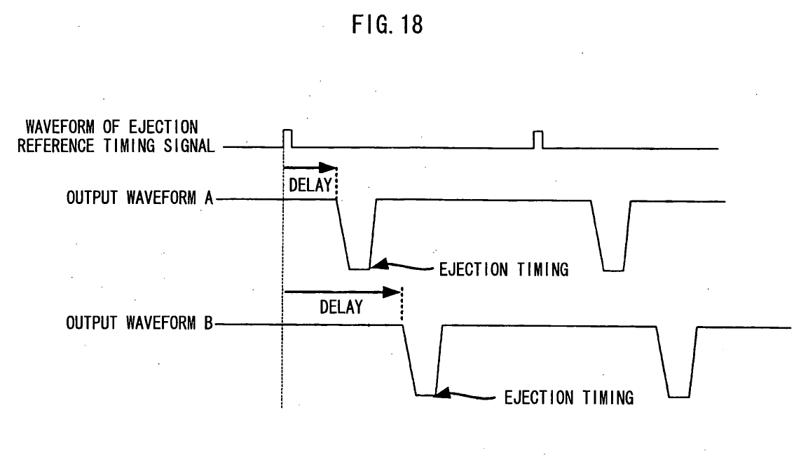

Accordingly, in the structure shown in FIG. 17, there is a large possibility that the nozzle A and B are driven at timings offset from each other as shown in FIG. 18. FIG. 18 shows an example that the nozzle A is driven at timing delayed from the time the ejection reference timing signal rises and thereafter the nozzle B is driven after the nozzle A is driven.

As described above, the nozzles may be divided to a plurality of areas and may be driven at different timings, respectively. In this case, since the positions of respective pixels may be disposed more at random after an image is formed than the case that all the nozzles are offset at the same timing, irregular pixels are less recognized visually.

As described above, in the exemplary embodiment, even if a head, in which an image formed by it is liable to be affected even by a minute change in a speed, the image is less affected by the change in the transport speed by employing the simple structure described above, and high image quality may be secured.

Further, even if a less accurate, that is, cheep speed detection mechanism (encoder) is used, an inkjet recording apparatus having high image quality may be provided by applying the exemplary embodiment.

Although the inkjet recording apparatus has been explained as one example of the image forming apparatus of the exemplary embodiment, the scope to which the present invention is applied is not limited to the inkjet recording apparatus. The invention may be also applied to image forming apparatuses employing various systems such as a heat transfer recording apparatus having a recording head using a thermal device as a record device, an LED electronic photograph printer having a recording head using an LED device as a recording device, a silver halide photography printer having an LED line exposure head in addition to the inkjet system.

Further, the flow of the processing of the flowchart explained above is only an example, and it is needless to say that the orders for performing the respective processing may be changed, new steps may be added, and unnecessary steps may be deleted within a scope which does not depart from the gist of the invention.

1. An image processing apparatus comprising:
a timing signal generation unit that generates a timing signal showing timing at which an image forming unit is driven to form an image on a recording medium that is transported by a transport unit that transports the recording medium on which the image is to be formed;
a delay time information output unit that outputs, when the timing signal is generated by the timing signal generation unit, delay time information showing a delay time from the time at which the timing signal is generated to the time at which the image forming unit is driven with delay so that positions of pixels formed by the image forming unit are offset within the range of one pixel with respect to a transport direction, as compared with positions of pixels which are formed when the image forming unit is driven at the time the timing signal is generated; and
a drive unit that drives the image forming unit after the delay time shown by the delay time information that is output by the delay time information output unit elapses.

2. The image processing apparatus according to claim 1, further comprising a random number generation unit that generates a random number,
wherein the delay time information output unit outputs delay time information showing a delay time based on the random number generated by the random number generation unit.

3. The image processing apparatus according to claim 1, further comprising a delay time memory unit that stores delay time information showing a plurality of predetermined delay times,
wherein the delay time information output unit outputs the delay time information based on the plurality of delay time information stored in the delay time memory unit.

4. An image forming apparatus comprising
an image processing apparatus comprising:
a timing signal Generation unit that generates a timing signal showing timing at which an image forming unit is driven to form an image on a recording medium that is transported by a transport unit that transports the recording medium on which the image is to be formed;
a delay time information output unit that outputs, when the timing signal is generated by the timing signal generation unit, delay time information showing a delay time from the time at which the timing signal is generated to the time at which the image forming unit is driven with delay so that positions of pixels formed by the image forming unit are offset within the range of one pixel with respect to a transport direction, as compared with positions of pixels which are formed when the image forming unit is driven at the time the timing signal is generated; and
a drive unit that drives the image forming unit after the delay time shown by the delay time information that is output by the delay time information output unit elapses.

5. An image processing method comprising:
generating a timing signal showing timing at which an image forming unit is driven to form an image on a recording medium that is transported by a transport unit that transports the recording medium on which the image is to be formed;
outputting, when the timing signal is generated, delay time information showing a delay time from the time at which the timing signal is generated to the time at which the image forming unit is driven with delay so that positions of pixels formed by the image forming unit are offset within the range of one pixel with respect to a transport direction, as compared with positions of pixels which are formed when the image forming unit is driven at the time the timing signal is generated; and
driving the image forming unit after the delay time shown by the output delay time information elapses.
